(19) United States
(12) Patent Application Publication
(10) Pub. No.: US 2014/0011675 A1
(43) Pub. Date: Jan. 9, 2014

(54) AGRICULTURAL COMPOSITIONS AND APPLICATIONS UTILIZING MINERAL COMPOUNDS

(71) Applicant: Ralco Nutrition, Inc., Marshall, MN (US)

(72) Inventors: Brian Jon KNOCHENMUS, Lynd, MN (US); Samuel TUTT, Balaton, MN (US); Richard Dale LAMB, Balaton, MN (US); Evan JOHNSON, Balaton, MN (US); David BRADLEY, Tracy, MN (US); Jon HANSEN, Westbrook, MN (US)

(21) Appl. No.: 13/935,866

(22) Filed: Jul. 5, 2013

Related U.S. Application Data
(60) Provisional application No. 61/668,383, filed on Jul. 5, 2012.

(51) Int. Cl. C05B 17/00; C05F 11/00; A01G 1/00; C05G 3/02

(52) U.S. Cl. CPC C05B 17/00; C05G 3/02; C05F 11/00; A01G 1/001
USPC 504/101; 71/27; 504/206; 71/21; 71/17; 71/23; 47/58.1 R

(57) ABSTRACT

Embodiments provide inorganic mineral chelated compositions, cobalt compounds and compositions, and treatment compositions, and methods of making and using them. Mineral chelated compositions and cobalt compounds have been shown to improve plant health, plant emergence, crop yield, and plant resistance to disease and drought. The compositions described herein can be applied directly to seeds, soil, or plants, or they can be incorporated with existing agricultural treatments and processes, reducing cost and time for farmers to implement the methods described herein. Accordingly, the compositions can be used as a seed treatment, or they can be broadcast on soil, tilled in soil, placed in-furrow, mixed with other fertilizers or chemicals, side-dressed in the field, used as foliar treatments, or combinations thereof. Such methods provide valuable micronutrients in a highly bioavailable form to plants and soil.

### CROSS-REFERENCE TO RELATED APPLICATION

This application claims the benefit of Application No. 61/668,383, filed on 5 Jul. 2012 in the United States of America, and which application is incorporated herein by reference. A claim of priority is made.

### BACKGROUND

Nitrogen, potassium and phosphorus (i.e., “NPK”) often capture the focus of the agricultural industry as essential requirements for plant or crop growth and health. Calcium, magnesium and sulfur are sometimes measured and monitored as essential macronutrients required for healthy plant growth. In addition to these important ingredients, many trace inorganic minerals (i.e., micronutrients) have been found to further facilitate growth, yield and health in agricultural crops. Such micronutrients include chlorine, iron, boron, manganese, zinc, copper, molybdenum, sodium, silicon and cobalt.

Cobalt is essential for the growth of the rhizobium, a specific bacterium important in legumes that synthesizes vitamin B₁₂. Cobalt assists in nitrogen fixation in plants and increases the availability and uptake of other micro or even macro nutrients.

Other trace minerals found in the soil or supplemented in the soil have additional benefits. For example, zinc improves phosphorus utilization in plants, regulates growth, increases leaf size and corn ear size, promotes silking, hastens maturity and adds healthy weight to crops. Manganese improves nitrogen utilization, plays a vital role in pollination and aids cell energy release mechanisms. Iron is utilized in chlorophyll production and has a role in photosynthesis. Copper helps regulate a plant's immune system, controls mold and fungi, contributes to the photosynthesis process and increases stalk strength. Boron increases calcium uptake, is necessary for sugar translocation within the plant, promotes flowering and pollen production, and is required for cell division and plant growth.

Although naturally found in many types of soil, trace mineral amounts vary by geography, soil type, density of agricultural operations and supplemental programs. Limitations to providing ideal trace mineral supplies to plants or crops include farming costs, time, availability to the plant and chemical and physical compatibility with other agricultural compositions and farming equipment. For example, pre-treatment (or treatment prior to planting of seeds) of seeds with agricultural compositions is not widely utilized, with the exception of fungicides. The sensitivity of seeds to chemical and physical (churning, mixing, etc.) is high and the efficiency of coating and retaining the compositions is low. During agricultural operations, farmers and farming operations strive to remain profitable by reducing time in the field and the costs of additional chemical or biological applications.

With the significant increase in genetically modified organisms or “GMO” crops (e.g., RoundUp Ready® crops), the wide-spread use of the herbicide glyphosate (i.e., RoundUp® herbicide) has raised concerns. Glyphosate may not break down in the soil after contacting plants. The herbicide kills many types of soil microbes, including microbes that make micronutrients plant-available. Glyphosate strongly chelates micronutrients in the soil, including copper, iron, magnesium, manganese, nickel and zinc. Thus, the use of GMO crops can decrease herbicide costs at the expense of plant health. Accordingly, what are needed are seed treatment compositions and methods that help provide nutrients for plants to maintain and increase their health, for example, when the availability of important nutrients is reduced by the use of glyphosphate.

### SUMMARY

Embodiments of the present invention provide mineral products, seed treatment compositions, and methods of making and using such products and compositions. The use of these products and compositions can increase the growth, health, and yield of various plants such as crops and grasses.

Accordingly, embodiments of the present invention provide a seed, soil, or plant treatment composition comprising one or more of a mineral chelated compound and cobalt compound and optionally a fungicide, an inorganic fertilizer, an herbicide, an insecticide, a biological fertilizer, or a combination thereof. The treatment composition can optionally further include one or more adherents, one or more carriers, one or more enzymes, or combinations thereof.

The mineral of the mineral chelated compound can be, for example, cobalt, scandium, selenium, titanium, vanadium, chromium, manganese, iron, nickel, copper, zinc, or a combination thereof. The chelate or ligand of the mineral chelated compound can be, for example, lactate, propionate, butyrate, EDTA, acetate, or the like, or a combination thereof.

The composition can be further combined with, for example, an inorganic fertilizer, an herbicide, an insecticide, a biological fertilizer, or combinations thereof. Such compositions can be applied to seeds, soil, or plants.

Embodiments of the present invention further provide a method of treating seeds, soil, or a plant comprising applying a treatment composition described herein to a seed, to soil, or to a plant, wherein the treatment composition provides a rapidly soluble mineral chelated product to the seeds, soil, or plant to promote seed growth or germination, to promote Azotobacter growth in the soil, to promote plant growth and drought resistance, or a combination thereof.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a block flow diagram of a method of using a mineral chelated compound in pre-treatment of seeds, according to some embodiments.

FIG. 2 illustrates a block flow diagram of a method of using a cobalt compound in pre-treatment of seeds, according to some embodiments.

FIG. 3 illustrates a block flow diagram of a method of using a mineral chelated compound in-furrow, according to some embodiments.

FIG. 4 illustrates a block flow diagram of a method of using a cobalt compound in-furrow, according to some embodiments.

FIG. 5 illustrates a block flow diagram of a method of using a mineral chelated compound and inorganic fertilizer mixture, according to some embodiments.

FIG. 6 illustrates a block flow diagram of a method of using a cobalt compound and inorganic fertilizer mixture, according to some embodiments.

FIG. 7 illustrates a block flow diagram of a method of using a mineral chelated compound and herbicide mixture, according to some embodiments.

FIG. 8 illustrates a block flow diagram of a method of using a cobalt compound and herbicide mixture, according to some embodiments.

FIG. 9 illustrates a block flow diagram of a method of using a mineral chelated compound and insecticide mixture, according to some embodiments.

FIG. 10 illustrates a block flow diagram of a method of using a cobalt compound and insecticide mixture, according to some embodiments.

FIG. 11 illustrates a block flow diagram of a method of using a mineral chelated compound and biological fertilizer mixture, according to some embodiments.

FIG. 12 illustrates a block flow diagram of a method of using a cobalt compound and biological fertilizer mixture, according to some embodiments.

FIGS. 13A-C illustrate graphical views of the percent nitrogen, phosphorus and potassium (NPK) in plant vegetation, according to some embodiments.

FIGS. 14A-C illustrate graphical views of the percent nitrogen, phosphorus and potassium (NPK) in plant roots, according to some embodiments.

FIGS. 15A-D illustrate graphical views of soybean vegetation micronutrient content, according to some embodiments.

FIGS. 16A-D illustrate graphical views of soybean root micronutrient content, according to some embodiments.

FIGS. 17A-B illustrate graphical views of soybean yield, according to some embodiments.

FIGS. 18A-C illustrate graphical views of corn vegetative percent NPK, according to some embodiments.

FIGS. 19A-C illustrate graphical views of corn root percent NPK, according to some embodiments.

FIGS. 20A-B illustrate graphical views of corn vegetation and root weights, according to some embodiments.

FIGS. 21A-C illustrate graphical views of corn vegetation NPK concentration, according to some embodiments.

FIGS. 22A-C illustrate graphical views of corn vegetation micronutrient concentration, according to some embodiments.

FIG. 23 illustrates a graphical view of corn root wet weight, according to some embodiments.

FIGS. 24A-C illustrate graphical views of corn vegetation percent NPK, according to some embodiments.

FIGS. 25A-B illustrate graphical views of corn vegetation zinc and manganese content, according to some embodiments.

FIGS. 26A-D illustrate graphical views of corn yield, according to some embodiments.

FIG. 27 illustrates a graphical view of soybean vegetation cobalt content, according to some embodiments.

FIGS. 28 illustrates a graphical view of yield increase due to foliar application, according to some embodiments.

FIG. 29 illustrate a graphical view of soybean plant height, according to some embodiments.

FIG. 30 illustrates a graphical view of corn vegetation cobalt content, according to some embodiments.

### DETAILED DESCRIPTION

Embodiments of the invention relate to inorganic mineral chelated compositions and cobalt compounds and methods of making and using such compositions. Mineral chelated compositions and cobalt compounds of embodiments of the invention are shown to improve plant health, plant emergence, crop yield and plant resistance to disease and drought. In addition, the compositions described herein can be incorporated with many existing agricultural treatments and processes, reducing cost and time for farmers to implement. Compositions can be used as a seed treatment (sometimes called pre-treatment), broadcast on soil, tilled in soil, placed in-furrow, mixed with other fertilizers or chemicals, side-dressed in the field and used as a foliar treatment, or in combination of two or more of such applications to provide valuable micronutrients in an available form for the crops. Compositions discussed herein are beneficial to numerous agricultural crops and plants, including but not limited to corn, soybeans, alfalfa, sugar beets, potatoes, sod, and grass.

Applying the compositions in an agricultural application can include one or more of applying foliar, broadcasting on soil, tilling in soil, and in-furrow. Plant nutrient absorption capabilities are much greater in the root structure than in leafy or foliar regions, but foliar absorption of dilute nutrient solutions is practicable and is often a preferred agricultural product application method. Chelated nutrients provide an advantage by significantly enhancing foliar absorption, thereby allowing foliar nutrient application to partially or fully replace other application methods which are more expensive or damaging to plants.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

### Definitions

As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

The term “chelation” refers to the formation of two or more separate coordinate bonds between a polydentate (multiple bonded) ligand and a single central atom, typically a metal ion. The ligands are typically organic compounds, often in anionic form, and can be referred to as chelants, chelators, or sequestering agents. A ligand forms a chelate complex with a substrate such as a metal ion. While chelate complexes typically form from polydentate ligands, as used herein the term chelate also refers to coordination complexes formed from monodentate ligands and a central atom. Mineral chelated compositions include chelation.

A “carboxylic acid” refers to organic acids characterized by the presence of a carboxyl group, which has the formula —C(═O)OH, often written —COOH or —CO₂H. Examples of carboxylic acids include lactic acid, acetic acid, EDTA, propionic acid and butyric acid.

A “fatty acid” refers to a carboxylic acid, often with a long unbranched aliphatic tail (chain), which may be either saturated or unsaturated. Short chain fatty acids typically have aliphatic tails of six or fewer carbon atoms. Examples of short chain fatty acids include lactic acid, propionic acid and butyric acid. Medium chain fatty acids typically have aliphatic tails of 6-12 carbon atoms. Examples of medium chain fatty acids include caprylic acid, capric acid and lauric acid. Long chain fatty acids typically have aliphatic tails of greater than 12 carbon atoms. Examples of ling chain fatty acids include myristic acid, palmitic acid and stearic acid. A fatty acid having only one carboxylic acid group can be a ligand of a mineral.

The term “lactic acid” refers to a carboxylic acid having the chemical structural formula of CH₃CH(OH)CO₂H. Lactic acid forms highly soluble chelates with many important minerals.

As used herein, an “inorganic mineral compound” or “mineral” refers to an elemental or compound composition including one or more inorganic species. For example, an inorganic mineral compound may be cobalt, cobalt carbonate, zinc oxide, cupric oxide, manganese oxide or a combination thereof. Inorganic mineral compounds may also include scandium, selenium, titanium, vanadium, chromium, manganese, iron, nickel, copper and zinc, for example. Transition metals can also be included and salts, oxides, hydroxides and carbonates of the above mentioned compounds can be suitable inorganic mineral compounds.

As used herein, “mineral chelated compound” refers to chemical compound or mixture including at least one inorganic substance and a derivative of a carboxylic acid, or reaction product of a carboxylic acid and an inorganic mineral compound. Examples of mineral chelated compounds include but are not limited to cobalt, scandium, selenium, titanium, vanadium, chromium, manganese, iron, nickel, copper, zinc, or a combination thereof chelated to one or more ligands to form a chelate (a chelate complex or coordinate complex). Examples of suitable ligands include lactate, acetate, propionate, butyrate, ethylene diamine, and EDTA.

As used herein, an “inorganic fertilizer” refers to a composition intended to enhance the growth of plants by providing macronutrients such as one or more of nitrogen, potassium, phosphorus, calcium, magnesium, and sulfur. The inorganic fertilizer typically does not include significant amounts of living organisms. Inorganic fertilizers often include micronutrients, such as boron, chlorine, copper, iron, manganese, molybdenum and zinc. Inorganic fertilizers can also include optional ingredients such as greensand or rock phosphate. The inorganic fertilizer can be, for example, an NPK fertilizer, a known commercial fertilizer, or the like.

As used herein, “biological fertilizer”, “natural fertilizer” or “organic fertilizer” refers to a fertilizer that includes living organisms, or plant or animal matter. A biological fertilizer can include components such as manure, blood meal, alfalfa meal, seaweed, or compost. The fertilizers can be provided in a variety of granular or liquid forms.

As used herein, “pesticide” refers to a composition or product that kills or repels plant or seed pests, and may be broken into a number of particular sub-groups including, but not limited to, acaricides, avicides, bactericides, fungicides, herbicides, insecticides, miticides, molluscicides, nematicides, piscicides, predacides, rodenticides, and silvicides. Pesticides may also include chemicals which are not normally used as pest control agents, such as plant growth regulators, defoliants, and desiccants, or which are not directly toxic to pests, such as attractants and repellants. Some microbial pesticides may be bacteria, viruses, and fungi that cause disease in given species of pests. Pesticides may be organic or inorganic. Pesticides applied to plant seeds may remain on the surface of the seed coat following application, or may absorb into the seed and translocate throughout the plant.

As used herein, “herbicide” refers to a composition or product that kills or deters weed growth. One example of an herbicide includes glyphosate (i.e., RoundUp® herbicide).

As used herein, “insecticide” refers to a composition or product that kills or repels insects. Examples of insecticides include Sevin (carbaryl), permethrin, and bacillus thruingiensis

As used herein, “foliar” refers to the foliage of a plant or crop, or applying to the foliage of a plant or crop.

As used herein, “in-furrow” refers to applying a substance within a planting furrow in contact with or in near proximity to a seed. In-furrow application can occur before a seed is planted, simultaneous with seed planting, or after seed planting.

As used herein, “genetically modified plant” or “genetically modified organism” refers to an organism whose genetic material has been altered using genetic engineering techniques such as recombinant DNA technology.

As used herein, “rapidly soluble mineral chelated product” refers to a mineral chelated compound that has been altered to increase solubility in a solvent. Altering may include reducing in size, filtering, screening or chemically reacting. An inorganic mineral compound may be organically chelated such that its solubility changes from insoluble to soluble in a chosen solvent.

As used herein, “solution” refers to a homogeneous or substantially homogeneous mixture of two or more substances, which may be solids, liquids, gases or a combination thereof.

As used herein, “mixture” refers to a combination of two or more substances in physical or chemical contact with one another.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo. Accordingly, treating, tumbling, vibrating, shaking, mixing, and applying are forms of contacting to bring two or more components together.

As used herein, “applying” refers to bringing one or more components into nearness or contact with another component. Applying can refer to contacting or administering.

As used herein, “pre-treatment” or “seed treatment” refers to chemically and/or physically contacting seeds with a composition prior to planting.

As used herein, “reacting” refers to undergoing a chemical change. Reacting may include a change or transformation in which a substance oxidizes, reduces, decomposes, combines with other substances, or interchanges constituents with other substances.

As used herein, “transferring” refers to moving a component or substance from one place or location to another.

As used herein, “mold” refers to a hollow form or matrix for shaping a fluid, gel, semi-solid or plastic substance.

As used herein, “filtering” or “filtration” refers to a mechanical method to separate solids from liquids, or separate components by size or shape. This can be accomplished by gravity, pressure or vacuum (suction).

As used herein, “carrier” refers to a substance that physically or chemically binds or combines with a target or active substance to facilitate the use, storage or application of the target or active substance. Carriers are often inert materials, but can also include non-inert materials when compatible with the target or active substances. Examples of carriers include, but are not limited to, water for compositions that benefit from a liquid carrier, or diatomaceous earth for compositions that benefit from a solid carrier.

As used herein, “substrate” refers to a base layer or material on which an active or target material interacts with, is applied to, or acts upon.

As used herein, “stoichiometric” or “stoichiometric amounts” refer to starting materials of a reaction having molar amounts or substantially molar amounts such that the reaction product is formed with little to no unused starting material or waste. A stoichiometric reaction is one in which all starting materials are consumed (or substantially consumed) and converted to a reaction product or products.

As used herein, “adherent” refers to a material, such as a polymer, that facilitates contact or binding of one or more chemicals with a seed during a seed-pre-treatment process.

As used herein, “enzymes” refers to one or more biological molecules capable of breaking down cellulosic material.

Embodiments of the present invention provide a variety of treatment compositions for enhancing the germination rate, health, growth, and drought resistance of seeds and growing plants. The treatment compositions can also be used to improve the quality of soil.

One composition that can be used to treat seeds, plants, and soil is a mineral chelate or mineral chelated compound. A specific example of a mineral chelate is cobalt lactate (CoL). An additional or alternative composition includes a cobalt compound, such as cobalt carbonate, cobalt gluconate, cobalt sulphate, cobalt oxides, or a combination thereof.

The composition can include a variety of minerals, either as chelates or compounds. The chelates can be any suitable and effective chelate described herein. Examples of mineral chelated compounds include a cobalt chelated compound, a scandium chelated compound, a selenium chelated compound, a titanium chelated compound, a vanadium chelated compound, a chromium chelated compound, a manganese chelated compound, an iron chelated compound, a nickel chelated compound, a copper chelated compound, a zinc chelated compound, or a combination thereof. The chelated portion may include lactate, ethylenediamine tetraacetate (EDTA), propionate, butyrate, acetate and combinations thereof. Examples of a chelated mineral compound include mineral lactate compound, a mineral propionate compound, a mineral butyrate compound, a mineral EDTA compound, a mineral acetate compound, or a combination thereof.

The minerals of the mineral chelated compounds include cobalt, iron, manganese, copper, zinc, scandium, selenium, titanium, vanadium, chromium, manganese, nickel and molybdenum. For example, the cobalt, iron, manganese, copper, and zinc can be lactates, EDTA complexes, or sulfates, and the molybdenum can be hydrated molybdic acid.

The compositions can be prepared using carriers. Carriers are ideally inert materials which do not react with the active components of the composition chemically, or bind the active components physically by adsoption or adsorption. Liquid carriers include pure water, such as reverse osmosis water, or other liquids such as crop oils or surfactants which are compatible with the composition and plant tissue. The composition can be at least about 50% water by weight, at least about 75% water by weight, at least about 85% water by weight, or at least about 90% water. In some embodiments, the composition will be about 80% to about 99% water, about 85% to about 98% water, about 90% to about 95% water, or about 91% to about 94% water.

In some other compositions it is preferable to use solid carriers such as diatomaceous earth, finely ground limestone (CaCO₃), or magnesium carbonate (MgCO₃). Sugars such as sucrose, maltose, maltodextrin, or dextrose may also be used as solid carriers. In other compositions it is beneficial to use a combination of solid and liquid carriers.

The composition can also include a fiber, for example, a fiber that can act as a food source for beneficial bacteria in soil or another growth medium. Fiber can also act as an adherent. Soluble fibers are preferred as they generally enhance product efficacy and stability by keeping less soluble materials in solution or suspension due to their inherent charge and ability to disperse other charged components in solution. Soluble fibers also allow for higher composition-to-seed adhesion in pre-treatment. Fiber content within the composition is adjustable to better maintain less soluble materials in solution or suspension, and to modify composition “stickiness”. Higher fiber content and “stickiness” is often desirable in seed pre-treatments in order to ensure sufficient composition binding to and coverage of the seeds. Fiber content and type can also be modified to control composition-seed adhesion time, and adhesion strength. Because seeds can be pre-treated off-site and must be transported to farms, adhesion strength is important to ensure that pre-treatment compositions do not shake, rub, or fall off the seeds during processing, shipping, storage, or planting. The higher fiber content and overall concentration of pre-treatment compositions in comparison foliar and in-furrow application compositions may increase composition density. Lower fiber content may be preferable for liquid foliar or in-furrow application compositions, which ideally have lower percent solids and viscocities to allow for easier transport and application, and to minimize equipment clogging. Suitable and effective fibers include hemicellulose, for example, the hemicellulose extracted from Larch trees. Another example of a suitable fiber is a yucca plant extract, commercially available as Saponix 5000 or BioLiquid 5000.

The composition can further include one or more enzymes, including a blend of enzymes. The enzymes can serve to break down cellulosic material and other material, including stover left on a field after harvest. Useful and beneficial enzymes include enzymes which break down starch, such as amylases, enzymes which break down protein, such as proteases, enzymes which break down fats and lipids, such as lipases, and enzymes which break down cellulosic material, such as cellulases.

The composition can also include one or more compatible pesticides, such as glyphosate. The composition can include many different types of fungicides, which may contain active ingredients including but not limited to: chlorothalonil, copper hydroxide, copper sulfate, mancozeb, flowers of sulfur, cymoxanil, thiabendazole, captan, vinclozolin, maneb, metiram, thiram, ziram, iprodione, fosetyl-aluminum, azoxystrobin, and metalaxyl. The composition can include many different types of insecticides, which may contain active ingredients including but not limited to: aldicarb, acephate, chlorpyrifos, pyrethroids, malathion, carbaryl, sulfuryl fluoride, naled, dicrotophos, phosmet, phorate, diazinon, dimethoate, azinphos-methyl, endosulfan, imidacloprid, and permethrin. The composition can include many different types of herbicides, which may contain active ingredients including but not limited to: diuron, 2-methyl-4-chlorophenoxyacetic acid (MCPA), paraquat, dimethenamid, simazine, trifluralin, propanil, pendimenthalin, metolachlor-S, glyphosate, atrazine, acetochlor, “2,4-D”, methylchlorophenoxypropionic acid (MCPP), pendimethalin, dicamba, pelarganoc acid, triclopyr, monosodium methyl arsenate (MSMA), sethoxydim, quizalofop-P, primisulfuron, imazamox, cyanazine, bromoxylin, s-ethyl dipropylthiocarbamate (EPTC), glufosinate, norflurazon, clomazone, fomesafen, alachlor, diquat, and isoxaflutole.

In one embodiment, the composition is prepared to provide high percentages of aqueous soluble minerals. Additional optional components include forms of soluble calcium, boric acid, and the like.

In some embodiments, the composition is a general mineral complex, including a carrier, a mineral chelated compound (e.g., cobalt chelated compound), additional chelated or inorganic salts, soluble fiber, and enzymes. Some exemplary chelated or inorganic salts particular to this embodiment include salts of scandium, selenium, titanium, vanadium, chromium, manganese, iron, nickel, copper, zinc, molybdenum, or combinations thereof.

In some embodiments, a general mineral complex can contain up to 98% carrier, such as water, 0-40% of one or more mineral chelated compounds (e.g., cobalt chelated compound), 0-60% of one or more exemplary chelated or inorganic salts, 0-15% fiber, and 0-0.1 enzymes. In some such embodiments the fiber can be soluble.

Another composition that can be used to treat seeds, plants, and soil is a mineral lactate complex (MLC). A mineral lactate complex is typically a dry mixture of components that can be applied as a powder to a desired target (e.g., seed, plants, or soil). Components that can be included in a MLC composition include a mineral lactate (such as cobalt lactate), dextrose, copper sulfate, manganese sulfate, zinc sulfate, yucca extract, hemicellulosic fiber, and enzymes capable of digesting cellulosic fiber.

Another composition that can be used to treat seeds, plants, and soil is a treatment composition that includes a mineral chelate and various other components such as fiber and enzymes. A treatment composition of the invention can be an aqueous solution or aqueous dispersion or suspension.

In one embodiment, a cobalt mineral complex product can include about 85% to about 95% water, cobalt lactate, iron-EDTA or iron lactate, manganese-EDTA or manganese lactate, copper sulfate or copper lactate, zinc sulfate or zinc lactate, molybdic acid, soluble hemicellulosic fiber, and enzymes that can facilitate the degradation of cellulosic material.

In one specific embodiment, the treatment composition can include cobalt, chromium, manganese, iron, nickel, copper and zinc. The minerals can be partially or fully in a chelated form. In one embodiment, about 20-25% of the chromium is present as a chelate, about 20-25% of the manganese is present as a chelate, about 20-25% of the iron is present as a chelate, about 20-30% of the nickel is present as a chelate, about 20-30% of the copper is present as a chelate, and about 20-30% of the zinc is present as a chelate.

Within a mineral complex mixture or solution, the amount of mineral in chelated form may be less than 100% of the mineral present. For example, about 20% to about 30% of the mineral may be in a chelated form;

Many embodiments relate to compositions that can be used to treat seeds, plants, and soil include mixtures having natural, organic, inorganic, or biological fertilizers, or combinations thereof, with one or more compatible pesticides. These compositions may also contain enzymes, fibers, water, and minerals as discussed above. Such mixtures ensure or enhance seed germination and plant growth, health, and yield while protecting seeds and plants from infection or infestation and harsh conditions, such as drought. Seed pre-treatment has shown to be beneficial for a number of reasons. In general, seed pre-treatment will create a zone of pest suppression after planting in the immediate area of the seed. As a result, fewer pesticide application trips are required, which minimizes physical damage to plants, reduces application and handling costs, and cuts down on pesticide drift problems.

For some pests, such as fungal diseases, protectant seed treatments are preferable to post-infestation or post-infection treatments because the pathogens live in such close association with host plants that it can be difficult to kill the pest without harming the host. Other types of fungicidal seed pre-treatments include seed disinfestation, which controls spores and other forms of disease organisms on the seed surface, and seed disinfection, which eliminates pathogens that have penetrated into the living cells of the seed.

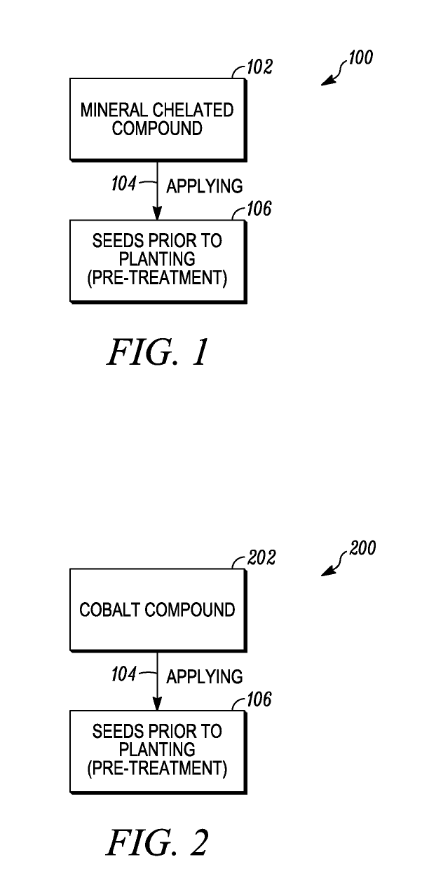

Referring to FIG. 1, a block flow diagram of a method 100 of using a mineral chelated compound in pre-treatment of seeds is shown, according to some embodiments. One or more mineral chelated compounds 102 can be applied 104 to one or more seeds prior to planting, such as in a pre-treatment stage 106.

Seed pre-treatment pesticides can be applied as dusts, but are often homogeneous solutions or heterogeneous slurries or suspensions. Seed treatment or pre-treatment 106 can be accomplished within a seed bag or by mechanical means, such as in a tumbler. The one or more seeds can be agitated after applying 104. Agitating can include tumbling, vibrating, mixing, shaking, and combinations thereof. The applying 104 can be accomplished by spraying, pouring or other means of contacting the mineral chelated compound and seeds. Applying 104 a mineral chelated compound can be performed at an end amount of about 4-5 grams/acre, about 2-5 gms/a, about 5-35 gms/a, about 25-70 gms/a, about 45-95 gms/a, about 75-140 gms/a, about 100-500 gms/a or about 5-5000 gms/a, for example. Seed pre-treatment can be carried out at an off-site facility, on-site at the farm, or on-board planting equipment immediately prior to planting.

The mineral chelated compound can be combined with one or more pesticides, including herbicides, insecticides, fungicides, and adherents, including commercial products, without negatively affecting the commercial product or seeds. The adherent can be a polymer (e.g., polysaccharide) such as a biocompatible and biodegradable adhesive material used in agricultural settings.

The mineral chelated compound can include one or more of a cobalt chelated compound, scandium chelated compound, selenium chelated compound, titanium chelated compound, vanadium chelated compound, chromium chelated compound, manganese chelated compound, iron chelated compound, nickel chelated compound, copper chelated compound and zinc chelated compound. The mineral chelated compound can also include one or more mineral lactate compounds, mineral propionate compounds, mineral butyrate compounds, mineral EDTA compounds, mineral acetate compound, or a combination thereof. Cobalt lactate is one specific example of a mineral chelated compound.

The mineral chelated compound can also include one or more enzymes, carriers, fiber, or a combination thereof. Examples of such compounds and methods of making are described in co-owned U.S. patent application Ser. No. 12/835,545.

Referring to FIG. 2, a block flow diagram of a method 200 of using a cobalt compound in pre-treatment of seeds is shown, according to some embodiments. One or more cobalt compounds 202 can be applied 104 to one or more seeds prior to planting, such as in a pre-treatment stage 106. Examples of cobalt compounds 202 include one or more of cobalt sulfate, cobalt carbonate, cobalt gluconate, and cobalt heptahydrate. Cobalt compounds 202 can be added to a mineral chelated compound in a seed treatment or replace a mineral chelated compound in seed treatment.

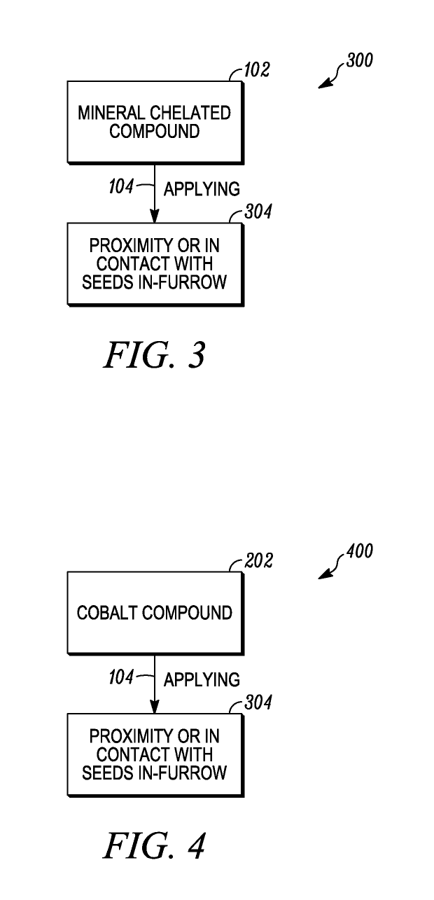

Referring to FIG. 3, a block flow diagram of a method 300 of using a mineral chelated compound in-furrow is shown, according to some embodiments. One or more mineral chelated compounds 102 can be applied 104 in proximity or in-contact with one or more seeds in-furrow 304. In order to save a farmer time and increase efficiency, one or more mineral chelated compounds 102 can be simultaneously or near-simultaneously placed in-furrow during planting. In-furrow fertilizers can be applied within proximity to a seed or in contact with a seed to promote more vigorous seedling growth by providing immediate nutrient supply to the plant roots. Proximity of in furrow fertilizer to seeds is determined based fertilizer compositions, such as ammonia and salt content that may be toxic to young seedlings. Soil type can also affect in-furrow fertilization efficacy as dryer, sandier soils can exacerbate root zone drying. Maintaining higher moisture content in soil can improve crop response to in-furrow fertilization by alleviating the effects of salt and ammonia. In addition to in-furrow, the mineral chelated compound can be introduced in a side-dress application, tilled in soil as a soil surface application, and combinations thereof. A mineral lactate is an example of a mineral chelated compound that can be placed in-furrow with a plant seed without risk or harm or incompatibility with the seeds or proximate chemical treatments.

In-furrow application compositions can be solids, homogenous liquids, or heterogeneous slurries. Liquid or slurry application compositions may be preferable as they can be applied using common agricultural sprayers and other like equipment. Referring to FIG. 4, a block flow diagram of a method 400 of using a cobalt compound in-furrow is shown, according to some embodiments. One or more cobalt compounds 202 can be applied 104 in proximity or in-contact with one or more seeds in-furrow 304.

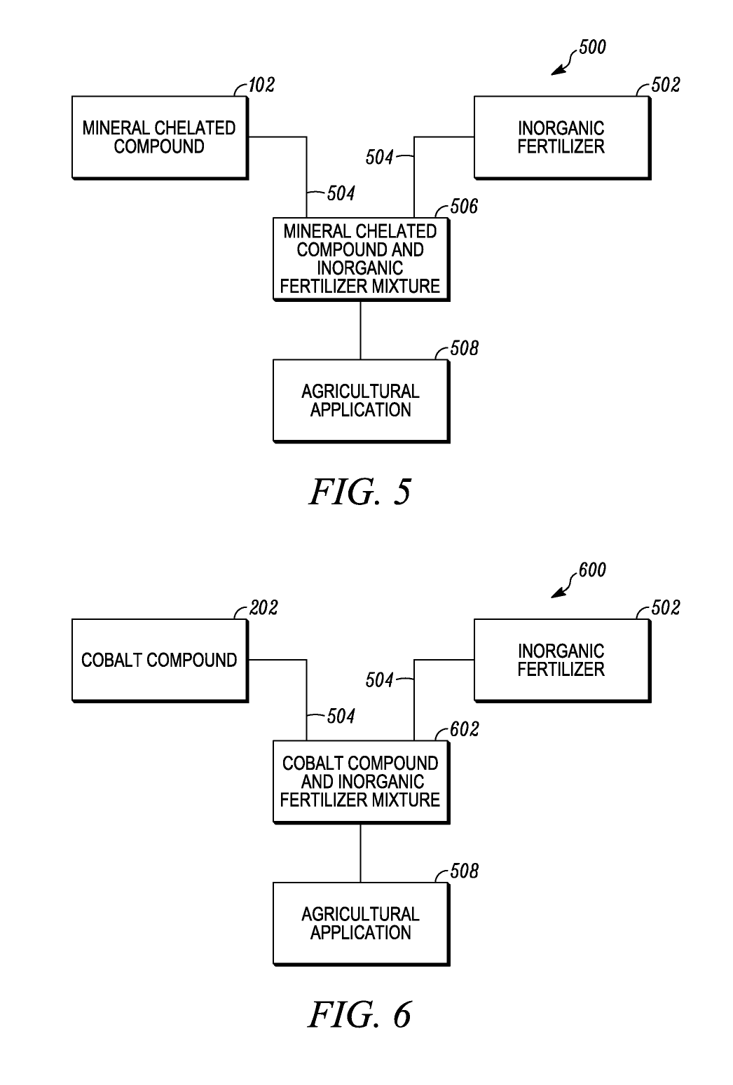

Referring to FIG. 5, a block flow diagram of a method 500 of using a mineral chelated compound (e.g., mineral lactate) and inorganic fertilizer mixture is shown, according to some embodiments. One or more mineral chelated compounds 102 can be contacted 504 or mixed with one or more inorganic fertilizers 502, sufficient to form a mixture 506. The mixture 506 can be used in an agricultural application 508. The applying the mixture in an agricultural application 508 can include one or more of applying to foliar, broadcasting on soil, tilling in soil, and in-furrow.

Referring to FIG. 6, a block flow diagram of a method 600 of using a cobalt compound and inorganic fertilizer mixture is shown, according to some embodiments. One or more cobalt compounds 202 can be contacted 504 or mixed with one or more inorganic fertilizers 502, sufficient to form a mixture 602. The mixture 602 can be used in an agricultural application 508.

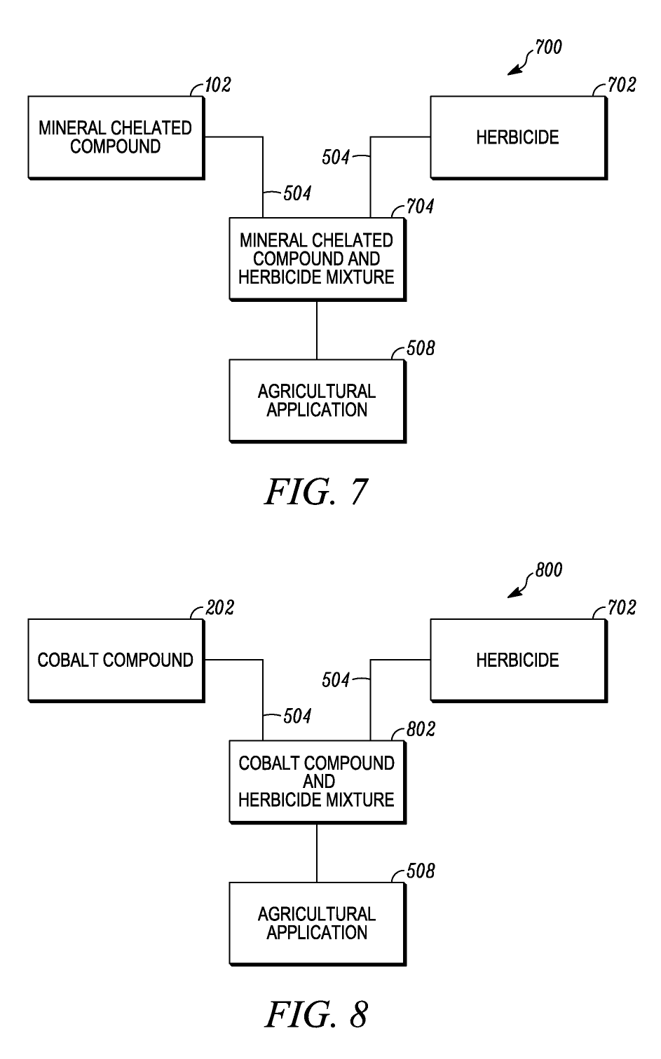

Referring to FIG. 7, a block flow diagram of a method 700 of using a mineral chelated compound (e.g., mineral lactate) and herbicide mixture is shown, according to some embodiments. One or more mineral chelated compounds 102 can be contacted 504 or mixed with one or more herbicides 702, sufficient to form a mixture 704. The mixture 704 can be used in an agricultural application 508.

Referring to FIG. 8, a block flow diagram of a method 800 of using a cobalt compound and herbicide mixture is shown, according to some embodiments. One or more cobalt compounds 202 can be contacted 504 or mixed with one or more herbicides 702, sufficient to form a mixture 802. The mixture 802 can be used in an agricultural application 508.

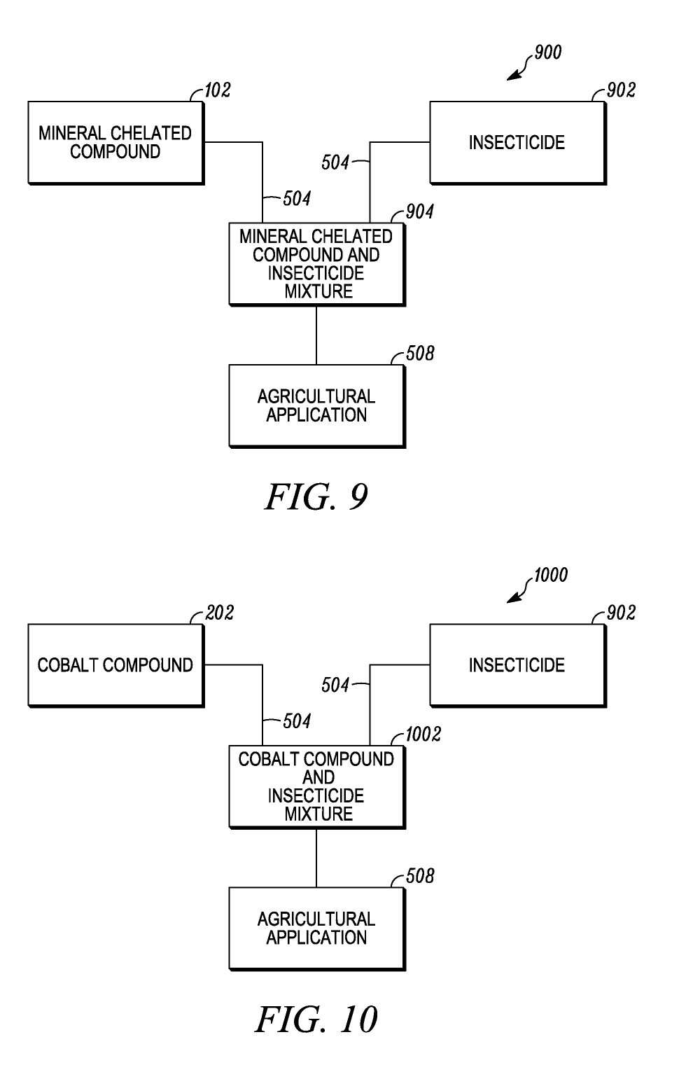

Referring to FIG. 9 illustrates a block flow diagram of a method 900 of using a mineral chelated compound (e.g., mineral lactate) and insecticide mixture is shown, according to some embodiments. One or more mineral chelated compounds 102 can be contacted 504 or mixed with one or more insecticides 902, sufficient to form a mixture 904. The mixture 904 can be used in an agricultural application 508.

Referring to FIG. 10, a block flow diagram of a method 1000 of using a cobalt compound and insecticide mixture is shown, according to some embodiments. One or more cobalt compounds 202 can be contacted 504 or mixed with one or more insecticides 902, sufficient to form a mixture 1002. The mixture 1002 can be used in an agricultural application 508.

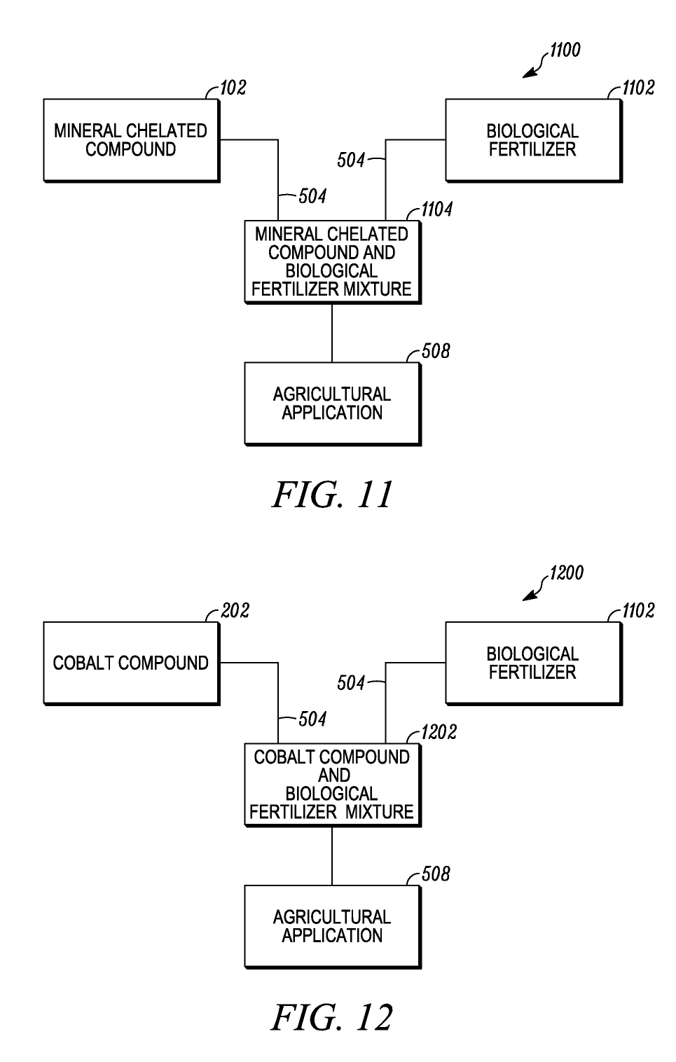

Referring to FIG. 11, a block flow diagram of a method 1100 of using a mineral chelated compound and biological fertilizer mixture is shown, according to some embodiments. One or more mineral chelated compounds 102 (e.g. mineral lactate) can be contacted 504 or mixed with one or more biological fertilizers 1102, sufficient to form a mixture 1104. The mixture 1104 can be used in an agricultural application 508.

Referring to FIG. 12, a block flow diagram of a method 1200 of using a cobalt compound and biological fertilizer mixture is shown, according to some embodiments. One or more cobalt compounds 202 can be contacted 504 or mixed with one or more biological fertilizers 1102, sufficient to form a mixture 1202. The mixture 1202 can be used in an agricultural application 508.

In some embodiments, a treatment method includes applying mineral products during multiple steps in a seed planting process. One or more mineral products can be applied to one or more seeds (for example, a bag of seeds). The seeds are planted, and then one or more mineral products can optionally be re-applied in-furrow.

In some embodiments, a method of making a rapidly soluble mineral chelated product includes contacting a carboxylic acid, such as lactic acid, with an inorganic mineral compound sufficient to form a solution. The solution may be reacted over a period of time, sufficient to provide a mineral chelated compound. The mineral chelated compound may then be transferred and be optionally reduced in size sufficient to provide a rapidly soluble mineral chelated product. Transferring may include transferring to one or more molds, prior to the compound substantially solidifying.

Carboxylic acid may be contacted with an inorganic mineral compound, such as by mixing. Molar amounts or stoichiometric amounts may be used. If the carboxylic acid is lactic acid, the carboxylic acid content may be about 60% to about 80% of the mixture by weight. The inorganic mineral compound may include about 20% to about 40% of the mixture by weight. More specifically, the lactic acid may include about 62% to about 76% and the inorganic mineral compound may include about 24% to about 38% by weight of the mixture. The lactic acid may be 88% strength lactic acid, for example.

When the carboxylic acid is propionic acid, the carboxylic acid content may be about 55% to about 75% by weight and the inorganic mineral compound content about 25% to about 45% by weight. More specifically, the propionic acid may include about 57% to about 72% and the inorganic mineral compound may include about 28% to about 43% by weight. When the carboxylic acid is butyric acid, the carboxylic acid content may be about 60% to about 80% by weight and the inorganic mineral compound content about 20% to about 40% by weight. More specifically, the butyric acid may include about 61% to about 76% and the inorganic mineral compound may include about 24% to about 39% by weight.

The carboxylic acid and inorganic mineral compound may be placed in a vessel, optionally with one or more catalysts. Examples of a catalyst include iron and alkaline earth metals. The vessel may be optionally agitated, such as by vibrating, shaking, turning or spinning. Water may be added to the vessel, before, during or after the contacting of carboxylic acid and inorganic mineral compound. Once a solution is formed, it may be reacted over a period of time. The reaction may initiate based solely on the contact between carboxylic acid and inorganic mineral compound, after addition or contact with a catalyst or similarly with the contact or addition of water of some combination thereof. Depending on the type of inorganic mineral compound utilized, carbon dioxide may be evolved as the solution heats up. Both water vapor and optionally carbon dioxide may be generated and released from the vessel. No reflux process is needed or desired, as often used conventionally with regard to related reactions. By-products may be passively and naturally removed, without the need for solvent removal or refluxing. Carbon dioxide and water may be released into the atmosphere, for example.

The reaction ultimately produces a mineral chelated compound. The mineral chelated compound may form a porous, brittle rock if left to solidify. The mineral chelated compound may then be transferred from the vessel to one or more molds, prior to the compound substantially solidifying. The molds may be of varying shapes or sizes, such that the compound may be easily handled and transported. Water vapor may be further driven off the compound as it solidifies within the one or more molds.

The mineral chelated compound may be reduced in size. Reducing the compound to a fine powder may increase its solubility, providing a rapidly soluble mineral chelated product. After contacting with a mill, the particles may be screened to further separate larger particles from smaller ones. Any larger particles may be placed back in the mill for further reduction in size. Screening may include filtering with a mesh. The mesh size may be about 50 to about 70 or about 50, about 60 or about 70 size mesh. The mesh size may less than 50 for example.

The rapidly soluble mineral chelated product may be further contacted with a carrier. The carrier may be a dry substrate or a liquid carrier, for example. The carrier may include one or more of diatomaceous earth, calcium carbonate, limestone, sugars, dextrose, water, ground corn cobs, starch and combinations thereof.

One example of the rapidly soluble mineral chelated product is organically chelated cobalt, for example, having the chemical formula: (CH₃—CH(OH)COO⁻)₂—Co which can be shown as:

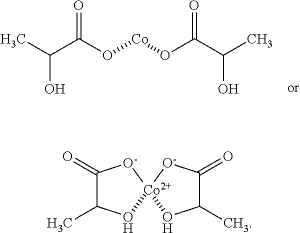

The metal chelated compound may include one or more of a cobalt lactate compound, zinc lactate compound, copper lactate compound, or manganese lactate compound. The carrier may include diatomaceous earth.

The mineral product discussed in various embodiments may include one or more mineral chelated lactates in addition to other components. The mineral product may include one or more metal sulfates, such as sulfates of manganese, zinc, copper or combinations thereof. The one or more mineral chelated lactates may be a cobalt lactate compound, zinc lactate compound, copper lactate compound or manganese lactate compound. A carrier may be utilized, such as dextrose. Additional components may include fibers, one or more enzymes, or combinations thereof.

The one or more mineral chelated lactates may be present in an amount of about 15% to about 20% of the product by weight. The one or more metal sulfates may be present in an amount of about 2% to about 10% of the product by weight. The fiber may be present in an amount of about 1% to about 5% of the product by weight. The enzymes may include about 0.1% to about 2% by weight, the yucca about 1% to about 5% by weight, and the carrier about 60% to about 80% by weight.

The treatment compositions described herein can be beneficial to a variety of seeds and plants. The compositions can be particularly beneficial to crops and grasses, and for improving the health of soil used for crops and grasses.

Examples of crop plants that benefit from treatment with the compositions described herein include, but are not limited to, corn, alfalfa, beans, sugar beets, potatoes, wheat, fruits, oats, cotton, rice, and the like. Additionally, GMO variants of the above plants can be strengthened and benefit from the embodiments of the present invention.

Examples of grasses that benefit from treatment with the compositions described herein include, but are not limited to, lawn grasses, turf grasses such as grass for sports fields and greens. Specific examples include Kentucky bluegrass, annual bluegrass, clover, Bermuda grass, bentgrass, ryegrass, Indian ricegrass, jointed goatgrass, purple threeawn grass, downy brome, common rye, and the like.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1

### Mineral Complex in Pre-treatment of Seeds Prior to Planting

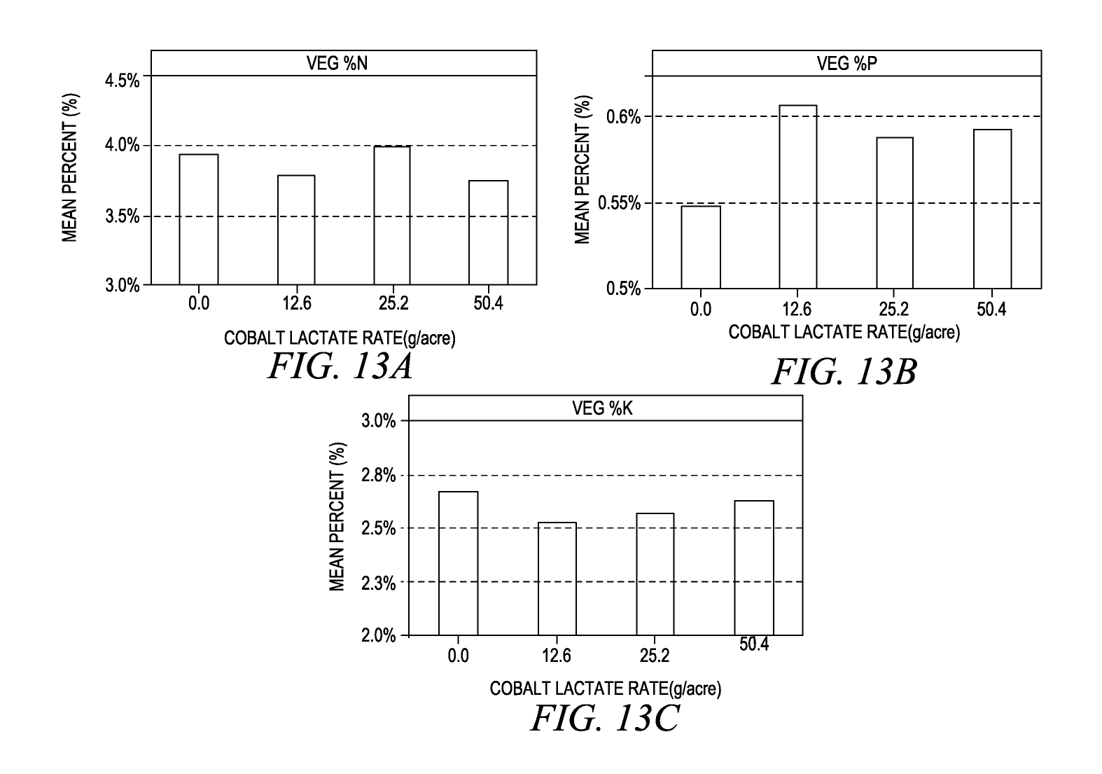

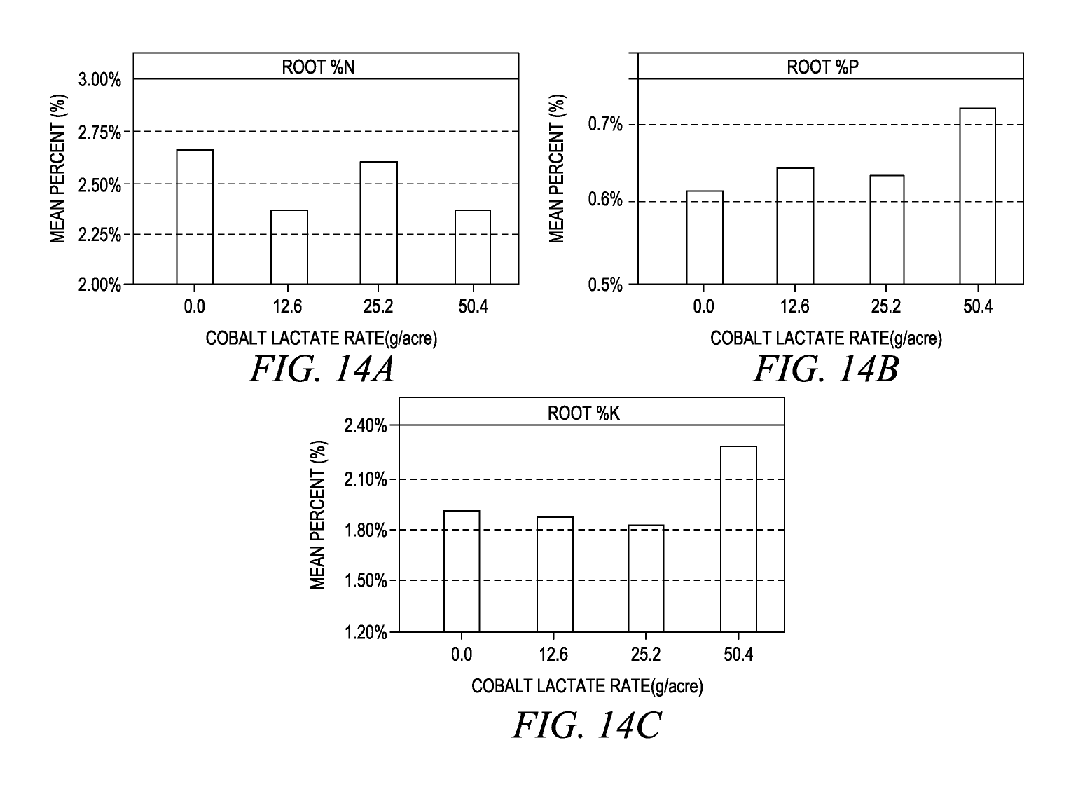

A general mineral complex formulation was applied as a dry powder seed treatment to soybean seeds at rates of 12.6 g, 25.2 g and 50.4 g cobalt lactate per acre in a greenhouse evaluation for macronutrient and micronutrient uptake. Four replicates per treatment were planted, each with one plant in a 6-inch diameter pot. FIGS. 13A, 13B and 13C, and FIGS. 14A, 14B, and 14C show the percent nitrogen, phosphorus and potassium (NPK) of the soybean vegetation and roots, respectively, at the varying application rates of cobalt lactate. The results show an increase in the nitrogen content of the soybean vegetation, and increases in both root phosphorus and potassium content. The increase in the macronutrient content within the soybean plant is vital to maintaining the overall plant health.

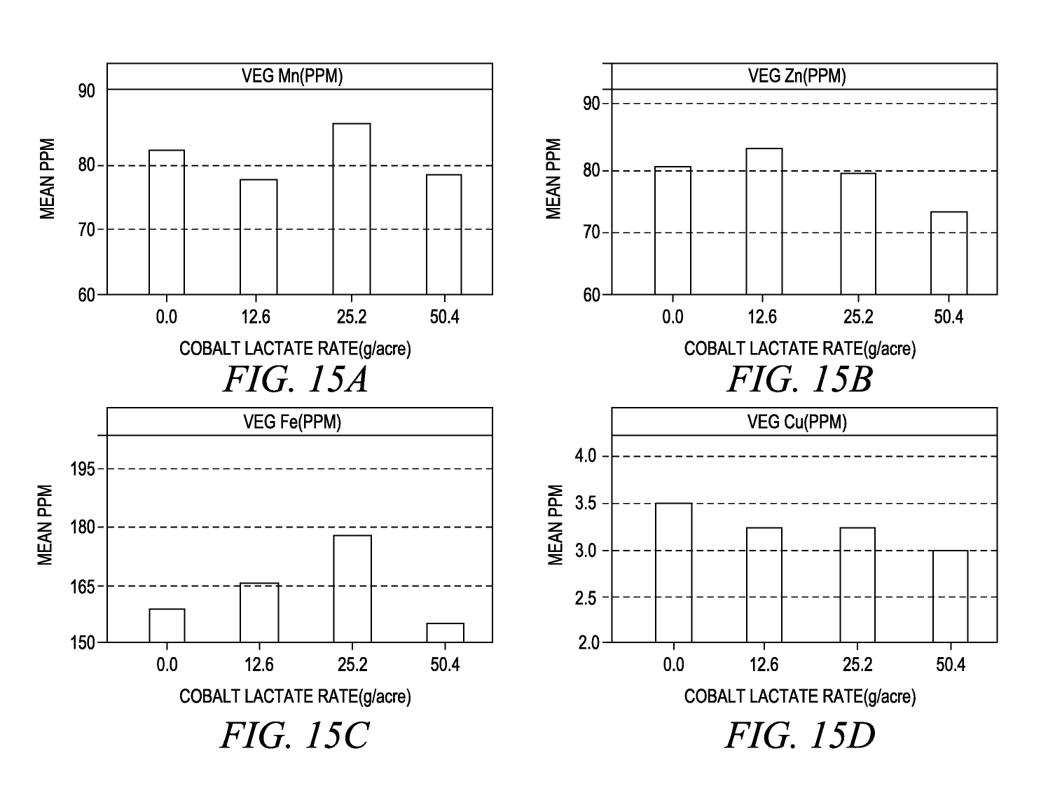

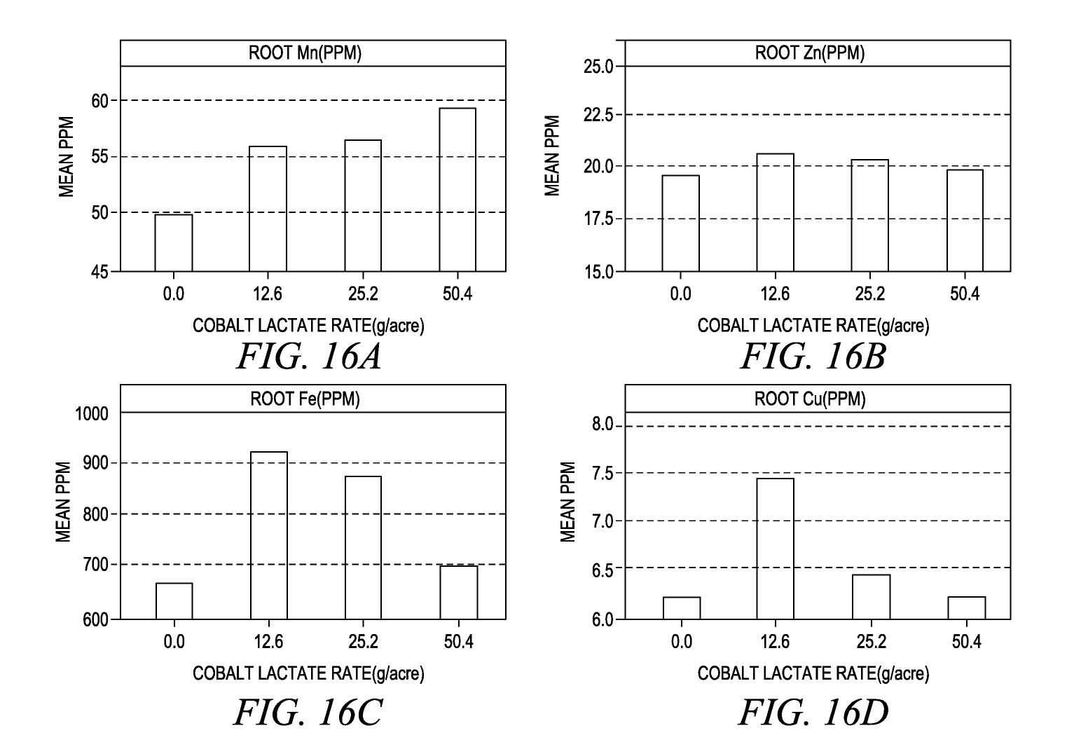

FIGS. 15A, 15B, 15C, and 15D, and FIGS. 16A, 16B, 16C, and 16D show the change in micronutrient content within the soybean vegetation and root, respectively, with varying amounts of cobalt lactate seed treatment.

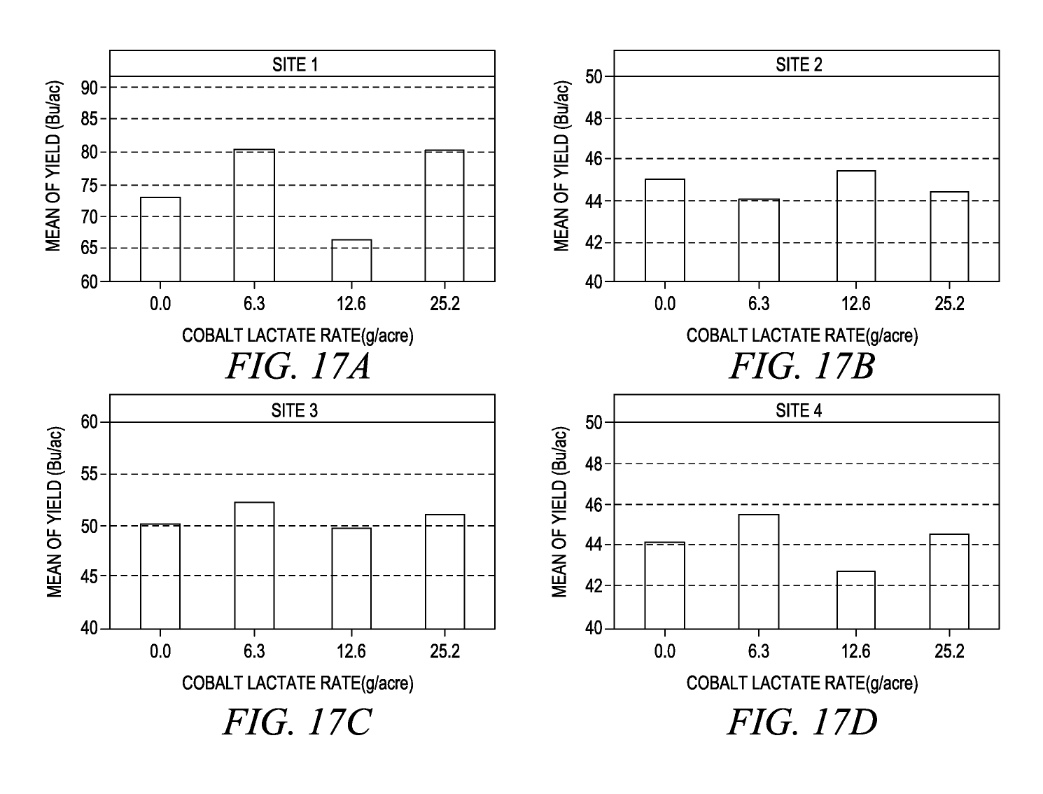

FIGS. 17A, 17B, 17C, and 17D show the effect on yield of the general mineral complex at varying rates of cobalt lactate when used as a seed pre-treatment prior to planting in a large field. The test was conducted at four individual test farms located in Minnesota and South Dakota. The average yield increase from the four test locations was 2.39 bushels per acre.

### Example 2

### Mineral Chelated Compound In-Furrow

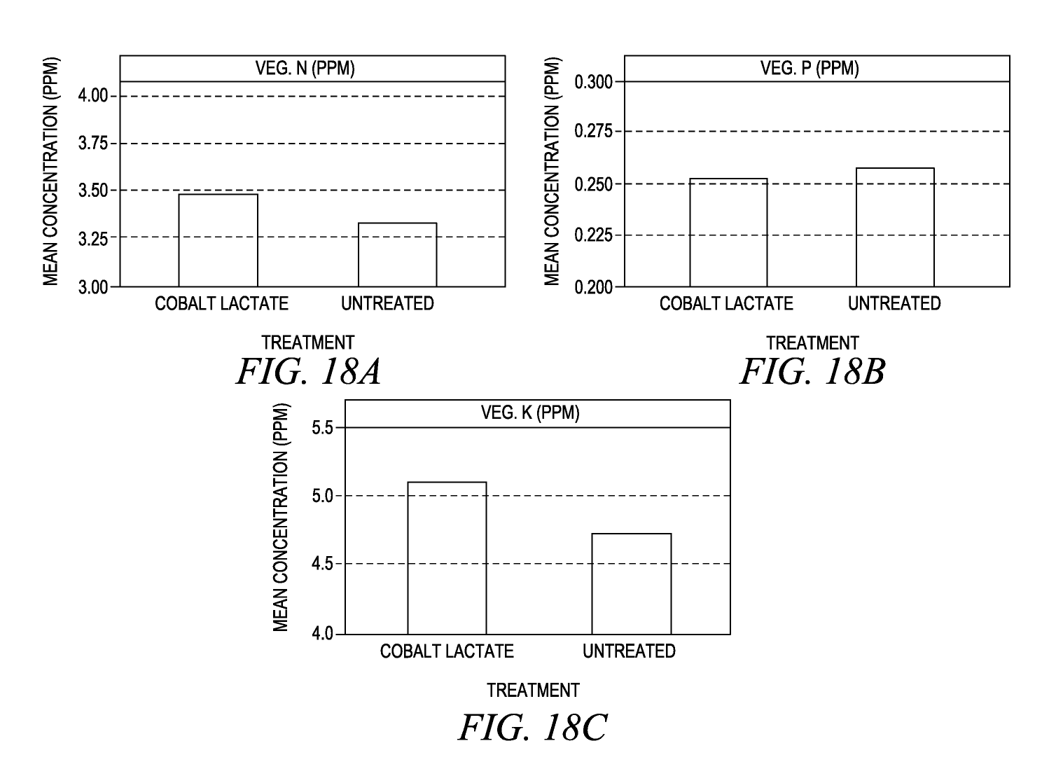

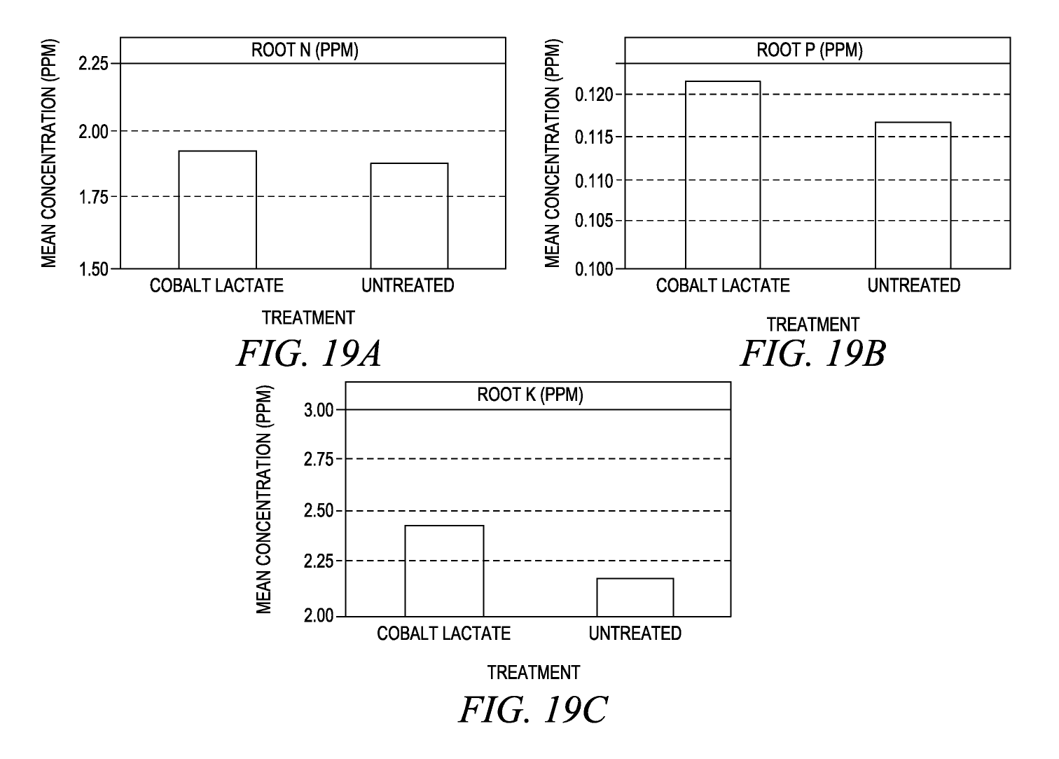

Cobalt lactate was applied to natural soil at a rate of 5 g cobalt per acre and compared to an untreated control. The cobalt lactate was added in-furrow with the field corn and grown under greenhouse conditions, using four replicates in a randomized complete block design. The plants were harvested after 53 days of growth and measured for plant health characteristics and nutrient uptake. FIGS. 18A, 18B and 18C, and FIGS. 19A, 19B, and 19C show vegetative and root concentration of NPK, respectively. An increase of 4.6% nitrogen and 7.8% potassium over the untreated control was observed, with no difference in phosphorus content within the soybean vegetation. The test showed a nitrogen, phosphorus and potassium concentration increase of 2.2%, 4.2%, and 12.2%, respectively, within the root over the untreated control.

### Example 3

### Cobalt Compound In-Furrow

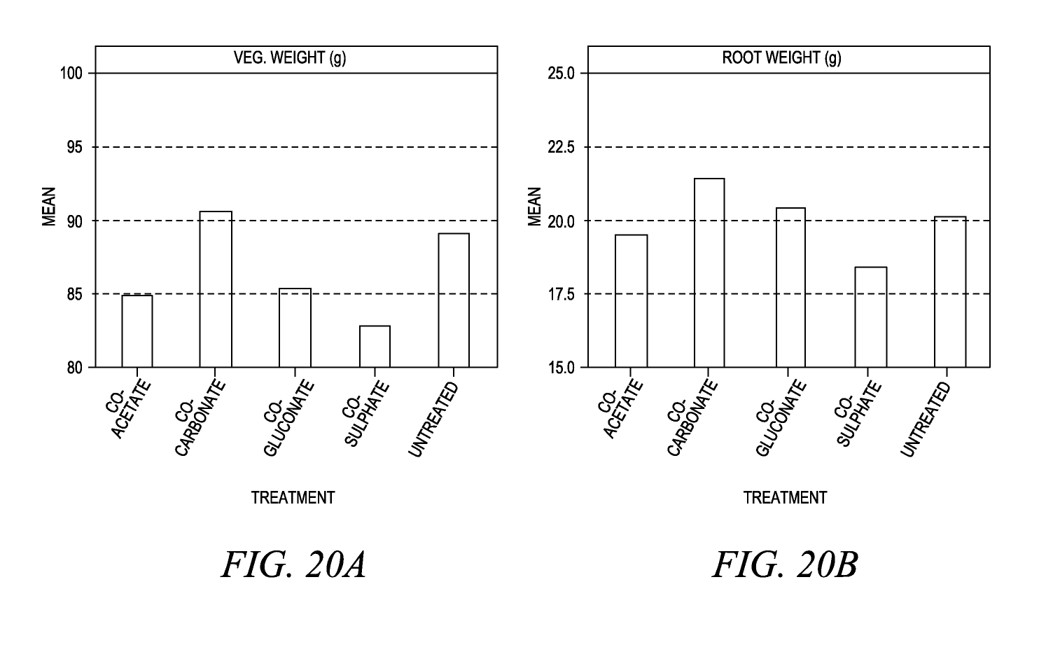

Various cobalt compounds were applied in-furrow to natural soil with corn seeded, then grown in greenhouse conditions. The cobalt compounds were applied at a rate of 5 g elemental cobalt per acre and compared to an untreated control. The compounds included: cobalt acetate, cobalt carbonate, cobalt gluconate and cobalt sulfate. The trial consisted of four replicates in a randomized complete block design. The plants were harvested after 53 days of growth and measured for plant health characteristics and nutrient uptake. FIGS. 20A and 20B show both vegetative and root wet weights as affected by the cobalt compounds. There was a slight increase in vegetative wet weight from the cobalt carbonate application, but a 6.7% increase in root mass. The increased root mass allows the root system to better expand throughout the soil. This provides greater access to the available nutrients, increasing the overall plant vegetation and/or root nutrient content.

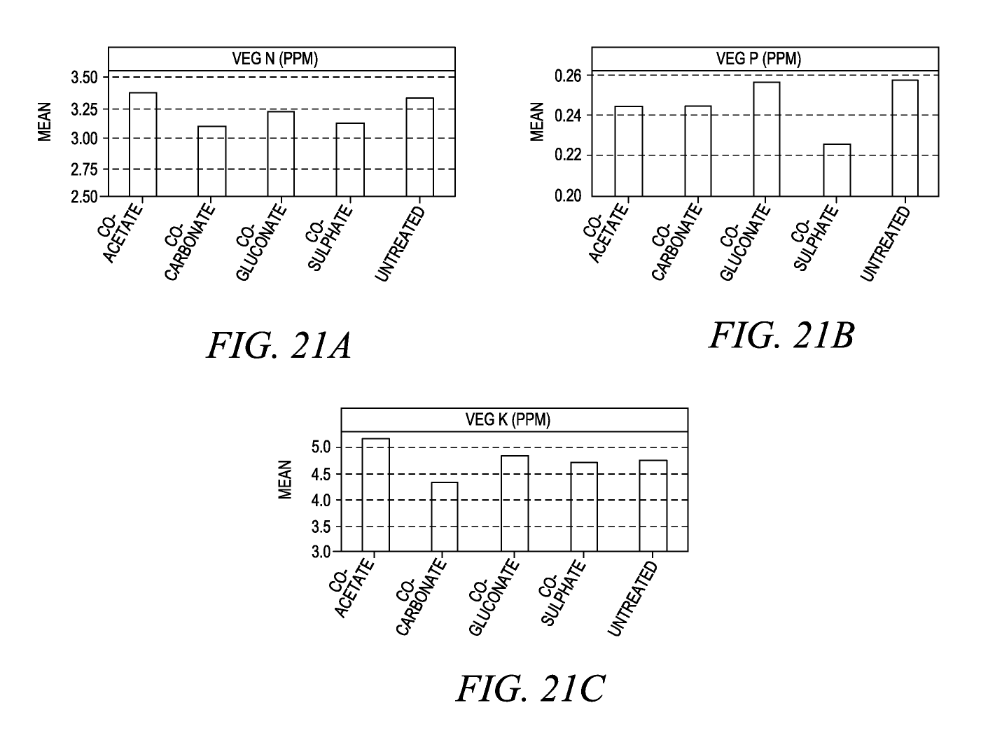

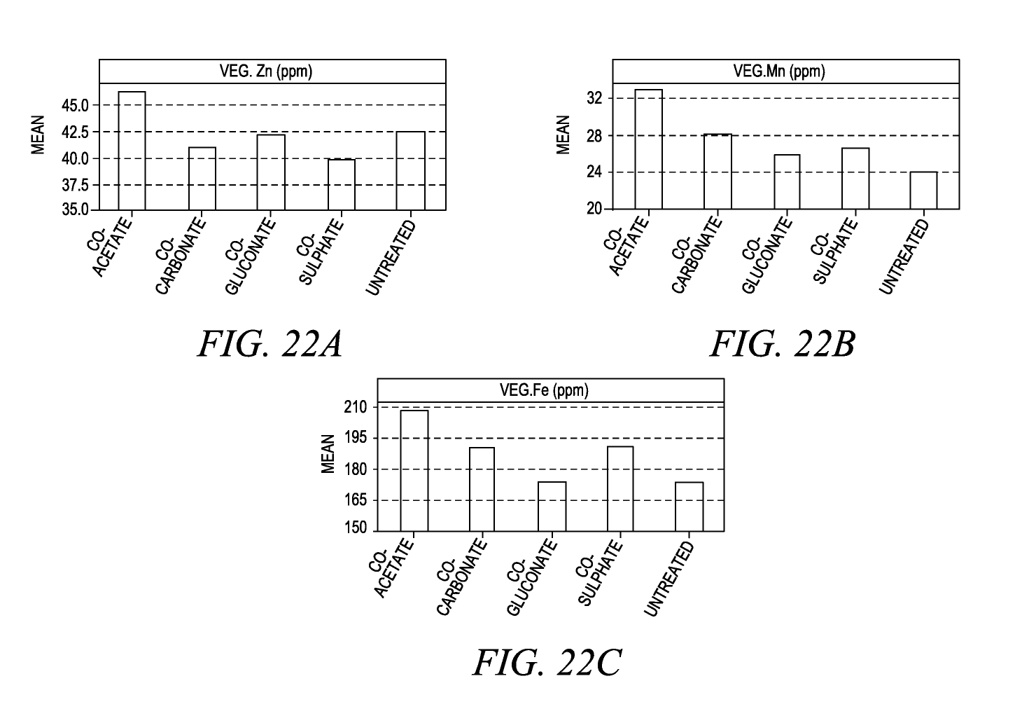

FIGS. 21A, 21B, and 21C, and FIGS. 22A, 22B, and 22C show the concentration, in ppm, of macronutrients NPK and micronutrients, zinc, manganese and iron in the vegetative tissue of the corn plants. There is an increase of 1.7% in the vegetative N content from the cobalt acetate application, but larger increases in K concentrations of 9.3% and 2.3% with cobalt acetate and cobalt gluconate, respectively. FIGS. 22A, 22B, 22C show tissue concentration increases of 9.4% Zn, 37.5% Mn and 20.9% Fe when treated with cobalt acetate. Additional increases in the micronutrient contents were shown with each of the other cobalt treatments.

### Example 4

### Mineral Chelated Compound with Inorganic Fertilizer

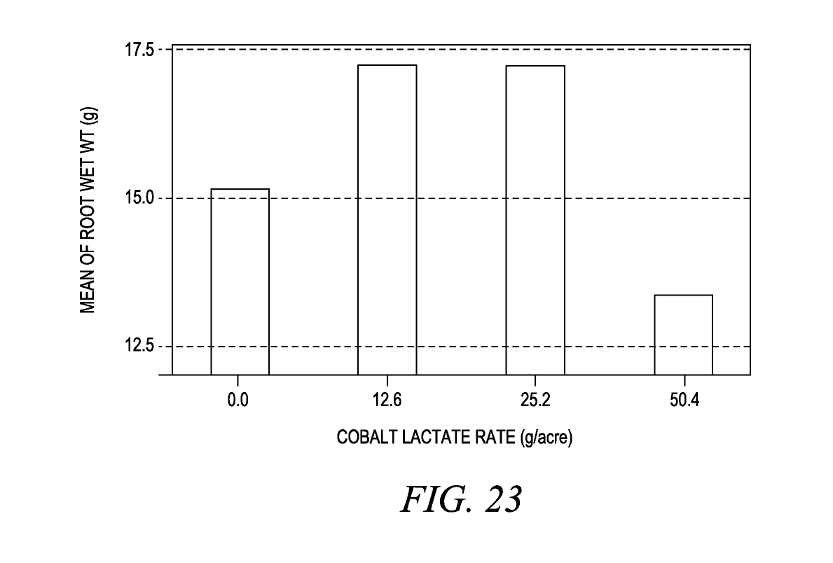

A general mineral complex formulation was applied as a liquid, in-furrow with corn seed in a greenhouse evaluation of cobalt lactate at 0.0, 12.6, 25.2, and 50.4 g/acre application rate. The product was applied with 10-34-0 starter fertilizer which had a use rate of 5 gal per acre. The early corn growth was monitored for plant health and nutrient uptake. FIG. 23 shows a noticeable increase in root wet weight with the 12.6 and 25.2 g/acre cobalt lactate treatments compared to the untreated control or the 50.4 g/acre rate.

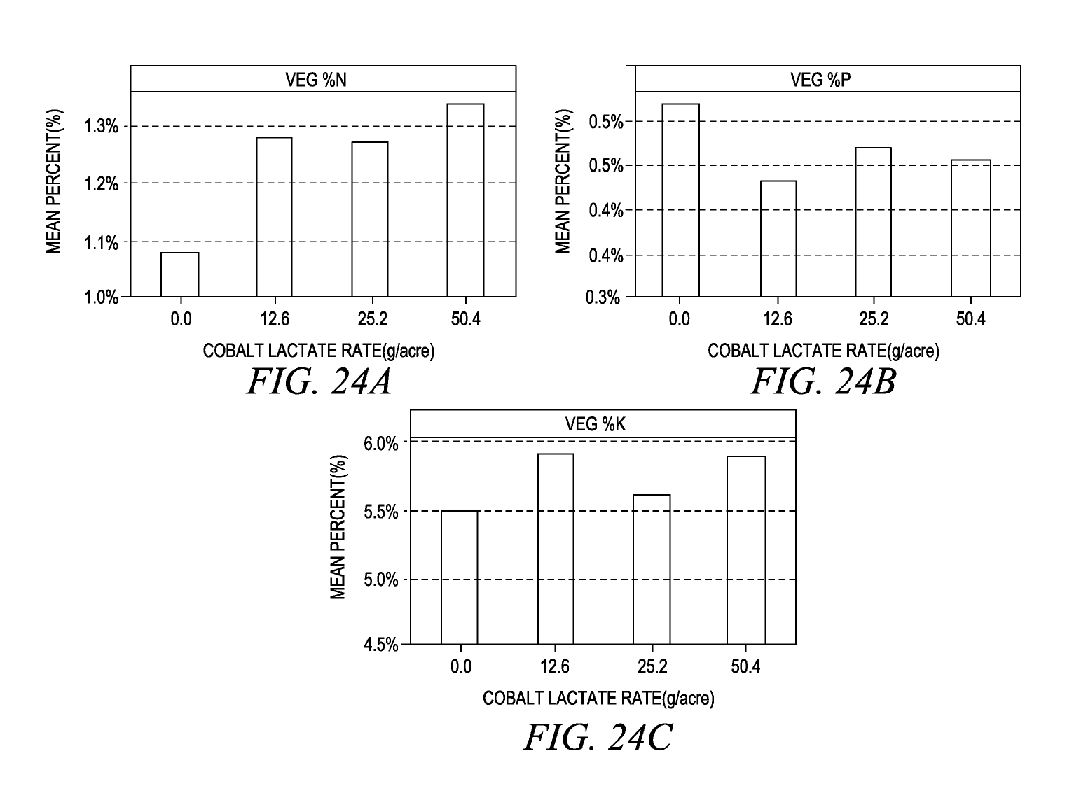

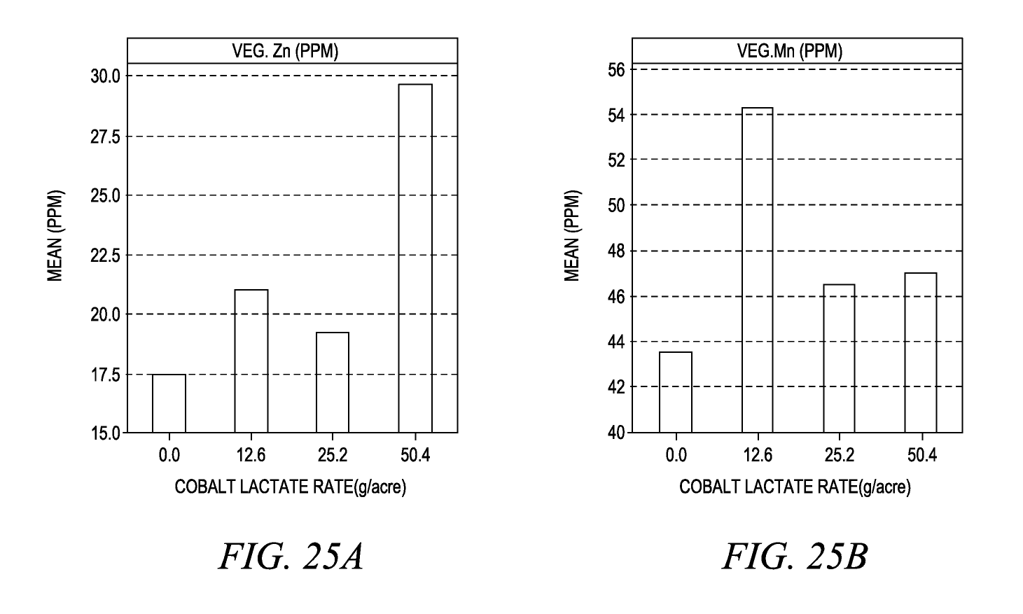

The increased root mass correlates to the higher concentrations of both macro- and micronutrients measured in the corn vegetative tissue as shown in FIGS. 24A, 24B, and 24C, and FIGS. 25A, and 25B, respectively.

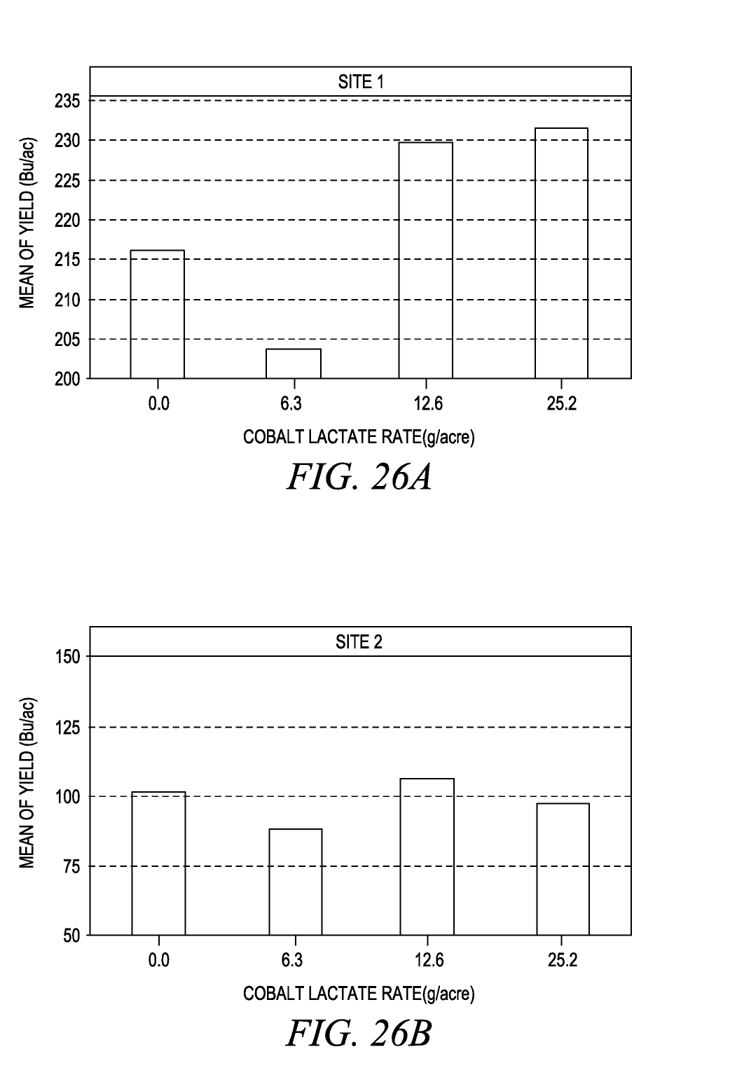

FIGS. 26A and 26B show the effect on yield of the mineral complex at varying rates of cobalt lactate when used in-furrow with corn in a production environment. The test was conducted at two individual test farms located in Minnesota, with 4 replications per treatment at each location. All treatments included 10-34-0 starter fertilizer at 3 gal/acre application rate. The tests showed that application rates of 12.6 g and 25.2 g of cobalt lactate per acre provided yield increases over the untreated control of 5.3% and 1.0% bushels per acre, respectively.

### Example 5

### Cobalt Compound with Inorganic Fertilizer

A general mineral complex, with 5.2 wt % cobalt lactate and water as a carrier was applied at a rate of 1 pt per acre onto granular NPK fertilizer. The fertilizer was then spread across the field at 2001 bs per acre and tilled in per the farmer's typical practices. The field trial had a yield increase of 4.64 bu/ac over the untreated, NPK only control.

### Example 6

### Mineral Chelated Compound with Herbicide

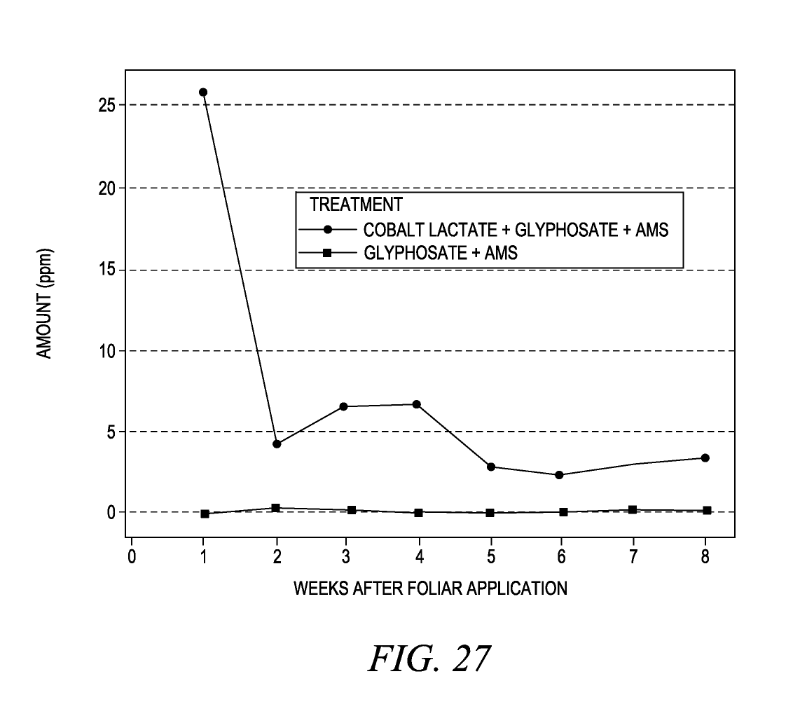

In this example, cobalt lactate from a general mineral complex, with 2.6 wt % cobalt lactate and water as a carrier was applied foliar to potted soybean plants using glyphosate herbicide and ammonium sulfate (AMS) a common water conditioning agent. The mineral chelated complex and glyphosate were both applied at foliar rates of lqt per acre, with 10 gallons of water per acre. The AMS was applied at a rate of 171 bs per 1001 bs of solution. The treatment was compared to the use of glyphosate and AMS alone and applied when the soybeans reached the third trifoliate growth stage. One sample from each treatment was analyzed once per week for eight weeks. FIG. 27 shows the foliar (vegetative) concentration of cobalt after the initial application of the treatments.

The figure shows that the cobalt is readily absorbed into the plant tissue, but translocated to the root zone prior to week 5. The absorption of the cobalt into the plant tissue and translocation to the root zone is needed to provide the microbial stimulation or expanded root growth as discussed in prior examples.

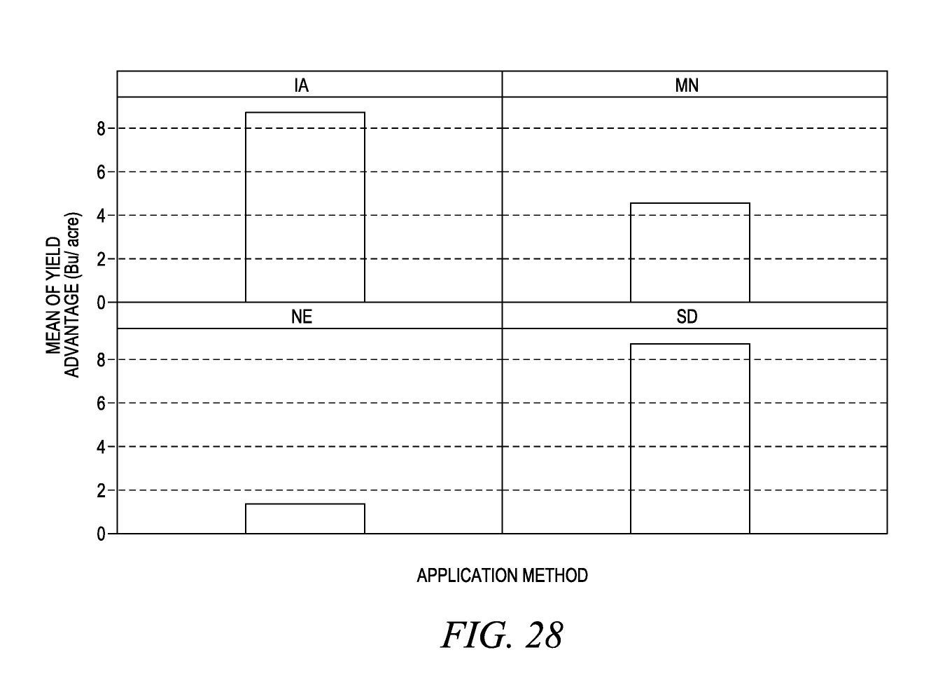

In 2011 and 2012, 40 trials using a foliar application of the general mineral complex were done throughout Minnesota (13 locations), South Dakota (11), Nebraska (8) and Iowa(8). The mineral complex was applied as described above and compared to a glyphosate/AMS only control. FIG. 28 shows the yield increase from the foliar application by state. Iowa and South Dakota each had an average yield increase of 8.9 bushels per acre over the glyphosate/AMS only treatment. Minnesota and Nebraska followed with 4.9 and 1.5 bushels per acre yield increases.

### Example 7

### Mineral Chelated Compound with Insecticide

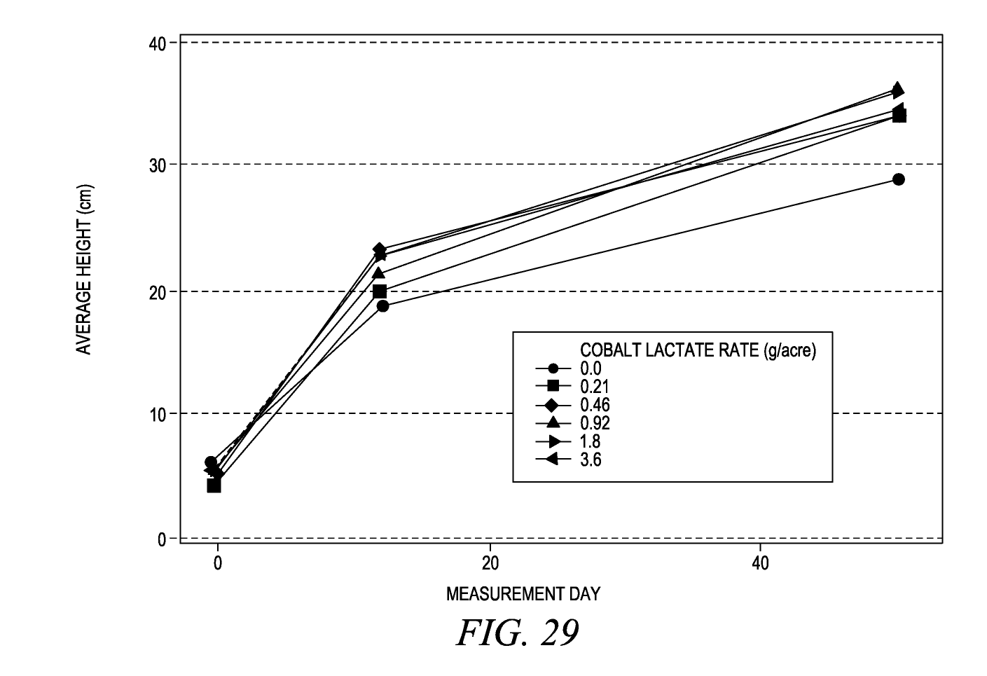

A general mineral complex formulation was applied to soybean seed prior to planting in combination with a fungicide (22% active trifloxystrobin) and insecticide (49% active imidacloprid) in a greenhouse evaluation of plant growth characteristics. The fungicide was applied at 0.32 fl oz per hundredweight (CWT) and the insecticide was applied at 2.4 fl oz per CWT to all test seed. The general mineral complex had 2.6 wt % active cobalt lactate and was applied at 0.1, 0.25, 0.5, 1 and 2 qts per acre of seed. The test plan used 501 bs of soybean seed per acre as the basis for product application. Three plant height measurements were taken over a span of 50 days, starting at 3 weeks after planting, as a means to measure initial plant growth and health. FIG. 29 shows the initial growth response of the potted soybean plants with the varying rates of cobalt lactate application. The graph shows that the use of cobalt lactate during the seed treatment process with an insecticide and fungicide can increase the growth rate of the plant over the insecticide and fungicide alone.

### Example 8

### Cobalt Compound with Herbicide

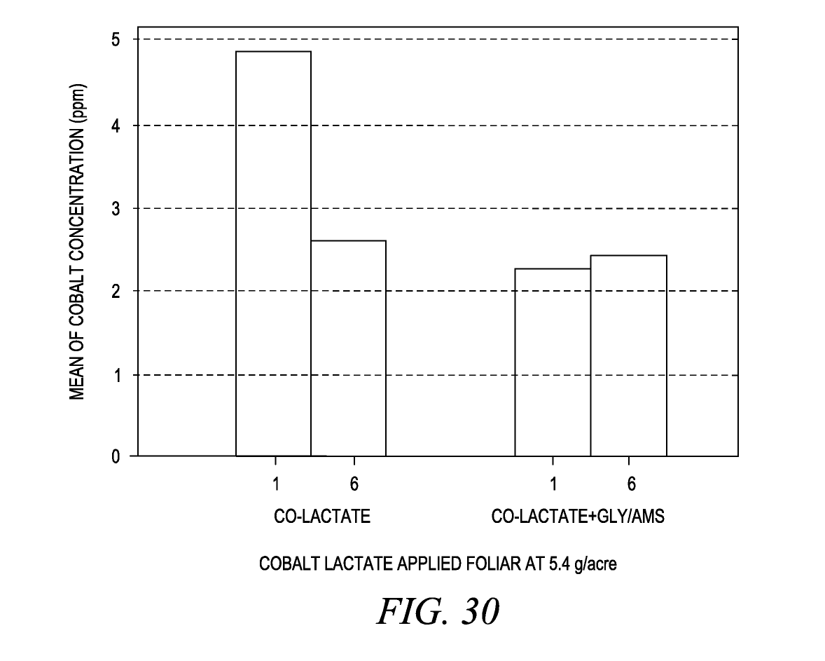

A greenhouse study was completed to evaluate the absorptivity of cobalt lactate into corn vegetative tissue when applied with and without glyphosate herbicide. The corn seeds were potted in natural soil and allowed to grow to the V4-V6 growth stage. At this time the plants were treated with foliar sprays of cobalt lactate, and cobalt lactate with glyphosate and ammonium sulfate (AMS). The glyphosate was commercially available and used at the recommended use rate of lqt per acre. The AMS was applied as described in Example 6. Six replicate vegetative portions of the plants were sampled at days 1 and 6 after the application and analyzed for cobalt content. FIG. 30 shows the cobalt concentration (ppm) found in the vegetative tissue at each sampling day.

The initial absorption rate was slowed with the addition of glyphosate and AMS to the cobalt lactate solution. However, the cobalt concentration after 6 days is consistent between the two treatments. This suggests that the cobalt concentration in the tissue was maintained for six days and the excess cobalt absorbed on day 1 from the cobalt lactate with glyphosate/AMS was translocated to the root zone of the plant.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values, e.g., weight percents, proximate to the recited range that are equivalent in terms of the functionality of the individual ingredient, the composition, or the embodiment.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A seed, soil, or plant treatment composition comprising:
a mineral lactate compound; and
a pesticide, an inorganic fertilizer, a biological fertilizer, and combinations thereof.

2. The treatment composition of claim 1 further comprising an adherent.

3. The treatment composition of claim 1 further comprising fiber, enzymes, a carrier, and combinations thereof.

4. The treatment composition of claim 3 wherein the carrier comprises water, diatomaceous earth, and combinations thereof.

5. The treatment composition of claim 1 wherein the pesticide, inorganic fertilizer, and biological fertilizer is dry.

6. The treatment composition of claim 1 wherein the pesticide, inorganic fertilizer, and biological fertilizer is liquid.

7. The treatment composition of claim 1 wherein the mineral lactate compound comprises cobalt lactate.

8. The treatment composition of claim 1 wherein the mineral lactate compound comprises one or more of cobalt, iron, manganese, copper, and zinc lactates.

10. The treatment composition of claim 1 wherein the inorganic fertilizer is an nitrogen-phosphorus-potassium (NPK) fertilizer.

11. The treatment composition of claim 1 wherein the herbicide comprises glyphosate.

12. A seed, soil, or plant treatment composition comprising:
a cobalt compound; and
a pesticide, an inorganic fertilizer, a biological fertilizer, and combinations thereof.

13. The treatment composition of claim 12 further comprising an adherent.

14. The treatment composition of claim 12 further comprising fiber, enzymes, a carrier, and combinations thereof.

15. The treatment composition of claim 14 wherein the carrier comprises water, diatomaceous earth, and combinations thereof.

16. The treatment composition of claim 12 wherein the pesticide, inorganic fertilizer, and biological fertilizer is dry.

17. The treatment composition of claim 12 wherein the pesticide, inorganic fertilizer, and biological fertilizer is liquid.

18. The treatment composition of claim 12 wherein the cobalt compound comprises cobalt carbonate, cobalt gluconate, cobalt sulphate, cobalt oxides, cobalt chelates.

19. The treatment composition of claim 18 wherein the cobalt chelates comprise one or more of a cobalt lactate, a cobalt propionate, a cobalt butyrate, a cobalt EDTA, a cobalt acetate, and combinations thereof.

20. The treatment composition of claim 12 wherein the composition further comprises chromium, manganese, iron, nickel, copper, zinc, and combinations thereof.

21. The treatment composition of claim 12 wherein the inorganic fertilizer is an NPK fertilizer.

22. The treatment composition of any one of claims 12 wherein the herbicide comprises glyphosate.

23. A method of treating seeds, soil, or a plant comprising:
applying a treatment composition to one or more of a seed, soil, and a plant, wherein the treatment composition provides a mineral lactate product to promote one or more of seed growth, germination, Azotobacter growth in the soil, plant growth, and drought resistance.

24. The method of claim 23 wherein the method comprises treating seeds.

25. The method of claim 24 wherein the applying comprises spraying the seeds with the treatment composition, pouring the composition over seeds, or passing the seeds through a volume of the treatment composition.

26. The method of claim 24 wherein the applying comprises agitating seeds after the treatment composition has been applied to the seeds.

27. The method of claim 26 wherein the agitating comprises tumbling, vibrating, mixing, shaking, stirring, or a combination thereof.

28. The method of claim 24 further comprising applying an herbicide, a fungicide, an insecticide, an adherent, and combinations thereof, to seeds.

29. The method of claim 24 wherein the treatment composition comprises a cobalt compound applied to one or more seeds prior to planting the one or more seeds.

30. The method of claim 23 comprising one or more of applying the treatment composition in-furrow and in proximity to planted seeds.

31. The method of claim 23 further comprising combining the treatment composition with an inorganic fertilizer to provide a mixture, and applying the mixture to seeds, soil, or plants.

32. The method of claim 31 wherein the inorganic fertilizer comprises an NPK fertilizer.

33. The method of claim 23 further comprising combining the treatment composition with an herbicide to provide a mixture, and applying the mixture to seeds, soil, or plants.

34. The method of claim 33 wherein the herbicide comprises a glyphosate.

35. The method of claim 23 further comprising combining the treatment composition with an insecticide to provide a mixture, and applying the mixture to seeds, soil, or plants.

36. The method of claim 35 wherein the insecticide comprises one or more of Sevin (carbaryl), permethrin, and bacillus thruingiensis.

37. The method of claim 23 further comprising combining the treatment composition with a biological fertilizer to provide a mixture, and applying the mixture to seeds, soil, or plants.

38. The method of any one of claims 23 wherein applying the mixture comprises one or more of applying to foliar, broadcasting on soil, tilling in soil, applying side-dress, and applying in-furrow.
